(19) United States
(12) Patent Application Publication
(10) Pub. No.: US 2011/0300264 A1
(43) Pub. Date: Dec. 8, 2011

(54) FROZEN INSTANT BEVERAGE PRODUCT

(76) Inventors: Edith Ramos da Conceicao Neta, Dublin, CA (US); Brian E. Farkas, Raleigh, NC (US)

(21) Appl. No.: 13/152,402

(22) Filed: Jun. 3, 2011

Related U.S. Application Data
(60) Provisional application No. 61/351,909, filed on Jun. 6, 2010.

(51) Int. Cl. A23L 2/38; A23G 9/04; C12G 3/00; A23L 2/52; A23C 9/123

(52) U.S. Cl. 426/61; 426/442; 426/590; 426/583

(57) ABSTRACT

A method of making a frozen instant beverage product, is carried out by (a) providing a chilled solution, the chilled solution comprising water and a freezing point depressant; (b) mixing the chilled solution with solid particles (e.g., ice particles and flavor particles) to produce a mixture thereof, the mixing step carried out at a temperature at which the frozen ice particles do not melt in the chilled solution; and then (c) forming the paste into the frozen instant beverage product. The frozen instant beverage product can be stored in frozen form for subsequent use, at which time it is combined with one or more beverages to produced a semi-frozen beverage for consumption.

### RELATED APPLICATIONS

The present application claims the benefit of U.S. provisional patent application Ser. No. 61/351,909, filed Jun. 6, 2010, the disclosure of which is incorporated by reference herein in its entirety.

### FIELD OF THE INVENTION

The present invention concerns frozen instant beverage products, methods of making such frozen products, and methods of making a semi-frozen beverage with such products.

### BACKGROUND OF THE INVENTION

Production of semi-frozen beverages such as milkshakes, smoothies, coffee-based drinks, slushies, and alcohol-based drinks (margaritas and daiquiris, for example) traditionally requires high-speed blending of ingredients. The result is an icy yet creamy beverage that is popular for commercial sale as well as in-home consumption. However, retail products are expensive and in-home production is inconvenient and time-consuming. In-home production is potentially dangerous, or at least difficult, for children due to the use of an electromechanical blender. The combination of these factors serves to limit the popularity and frequency of use of semi-frozen beverages, many of which have substantial health benefits, by consumers.

Non-frozen, prepackaged refrigerated beverages address some issues but do not provide the icy mouth-feel of a frozen, blended product. Prior systems for instant beverage products have been proposed (see, e.g., U.S. Pat. Nos. 7,615,245 and 7,615,246 to Sweeney et al.). However, obtaining the desired mouth-feel and texture presents a substantial challenge.

As such, there is a clear need for a convenient, preferably no-blender required, instant frozen beverage product that produces the desirable attributes of a traditional blender-based product while minimizing cost and production time, yet convenient for children in its mixing. The following invention and its methods of production address this need.

### SUMMARY OF THE INVENTION

A first aspect of the present invention is a method of making a frozen instant beverage product. The method comprises: (a) providing a chilled solution, said chilled solution comprising water and a freezing point depressant (e.g., a polyol); (b) mixing the chilled solution as a continuous phase with solid particles to produce a mixture or paste thereof, said solid particles comprising ice particles (e.g., consisting of or consisting essentially of frozen water) and optionally (but in some embodiments preferably) at least one additional type of solid particles (for example, particles including but not limited to flavor particles, fat particles, protein particles, and combinations thereof), with the mixing step carried out at a temperature at which the ice particles do not melt in the chilled solution; and then (c) forming the mixture or paste into the frozen instant beverage product (e.g., in the form of a plurality of pellets).

A second aspect of the invention is a frozen instant beverage product (e.g., in the form of pellets) comprising a continuous phase and a particulate phase; the continuous phase comprising water and a freezing point depressant, the particulate phase comprising ice particles and solid particles.

A third aspect of the invention is a method of making a semi-frozen beverage product, comprising: mixing a frozen instant beverage product as described herein with a beverage to produce the semi-frozen beverage product.

The foregoing and other objects and aspects of the present invention are explained in greater detail in the drawings herein and the specification set forth below.

### BRIEF DESCRIPTION OF THE DRAWINGS

FIG. 1: Example flow chart for a manufacturing process of the present invention.

FIG. 2: Schematic cross-sectional representation of an example pellet product of the present invention.

FIG. 3: Viscosity of a product of the present invention as compared to two commercially available smoothie products.

FIG. 4: Consumer responses of the product of the present invention as compared to two commercially available instant smoothie products on a 9 point hedonic scale where 1=extremely dislike and 9=extremely like.

FIG. 5: Schematic diagram of a manufacturing line for carrying out the process of the present invention.

### DETAILED DESCRIPTION OF THE PREFERRED EMBODIMENTS

The present invention now will be described more fully hereinafter with reference to the accompanying figures, in which embodiments of the invention are shown. This invention may, however, be embodied in many alternate forms and should not be construed as limited to the embodiments set forth herein. Like numbers refer to like elements throughout the description of the figures.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the present application and relevant art and should not be interpreted in an idealized or overly formal sense unless expressly so defined herein. The terminology used in the description of the invention herein is for the purpose of describing particular embodiments only and is not intended to be limiting of the invention.

Also as used herein, “and/or” refers to and encompasses any and all possible combinations of one or more of the associated listed items, as well as the lack of combinations when interpreted in the alternative (“or”).

The disclosures of all United States Patent references cited herein are to be incorporated by reference herein in their entirety.

### A. Definitions

“Freezing point depressant” as used herein may be any edible or nontoxic (e.g., “GRAS”) compound, including but not limited to polyols or polyalcohols such as xylitol, manitol, sorbitol, maltitol, erythritol, isomaltitol, lactitol (which may also serve as a sweetener), ethanol, glycerine, propylene glycol, sugars such as sucrose and dextrose, syrups such as honey and corn syrup, high fructose corn syrup etc. See, e.g., U.S. Pat. Nos. 7,727,573 and 6,468,576.

“Solid particles” as used herein includes, but is not limited to, flavor particles, yogurt particles, protein particles, fat particles, etc.

“Probiotic,” “probiotic bacteria” or “probiotic culture” are used interchangeably herein and may be any suitable probiotic culture, including but not limited to those comprising Lactobacillus acidophilus, Bifidobacterium lactis, Lactobacillus casei shirota, Lactobacillus gasseri, Lactobacillus reuteri, Bifidobacterium breve, Bifidobacterium longum, and combinations thereof. See, e.g., U.S. Pat. Nos. 7,794,744 and 7,101,565. The probiotic bacteria are preferably live and active and may be provided in any suitable form. In some embodiments they are provided in a dry particulate form (e.g., freeze-dried); in some embodiments they are provided in a liquid form.

“Prebiotic” as used herein may be any suitable prebiotic, including but not limited to oligosaccharides, including fructo-oligosaccharides, inulin, galacto-oligosaccharides, raffinose, etc. See, e.g., U.S. Pat. Nos. 7,794,744 and 7,101,565.

“Thickener” or “stabilizer” as used herein may be any suitable thickener or stabilizer, including but not limited to methylcellulose, carboxymethylcellulose, starches, gums such as xanthan, guar, carageenan, karaya, pectin, gelatin, alginates, locust bean, etc. See, e.g., U.S. Pat. Nos. 7,615,246; 6,673,384; and 6,180,159.

“Sweetener” as used herein may be any suitable natural or artificial, nutritive or non-nutrative, sweetener, including high-intensity sweeteners, examples of which include but are not limited to sucralose, sodium cyclamate, sodium saccharin, aspartame, and combinations thereof. See, e.g., U.S. Pat. No. 7,445,804.

“Ice particles” as used herein may be in any suitable form, but are preferably in the form of minute particles, such as shaved ice particles or artificial snow particles. The ice particles preferably consist essentially of water, e.g. without the addition of any freezing point depressant. The ice particles preferably consist essentially of crystalline ice, e.g., without inclusion of additional compounds or particulates therein.

“Yogurt particles” as used herein may be produced by any suitable technique, including freeze drying, spray drying, cryogenic grinding (eg., dry ice or liquid nitrogen) or shaving of frozen material and combinations thereof. In some embodiments the yogurt particles are shaved frozen yogurt particles. The yogurt may be unflavored or flavored (e.g., vanilla, chocolate, coffee, fruits such as cherry, blueberry, strawberry, banana, peach, lemon, lime, and combinations thereof), may be with or without live yogurt cultures, may be standard, low fat or non-fat yogurt, etc.

“Flavor particle” as used herein may be any suitable flavor particles, including fruit particles, vegetable particles, chocolate particles, coffee powder (spray-dried, vacuum dried or freeze-dried), etc., including combinations thereof. See, e.g., U.S. Pat. Nos. 7,615,246 and 5,532,022 The flavor particles may comprise candy particles, including gasified candy such as POP-ROCK™ brand gasified candy particles (e.g., as prepared in U.S. Pat. No. 4,289,794 to Kleiner et al.).

“Fruit particle” as used herein may be prepared by any suitable means, including cryogenic grinding (eg., dry ice or liquid nitrogen), or dehydrating (including air drying, freeze drying, and vacuum drying) etc. See, e.g., U.S. Pat. No. 6,287,612. Any suitable fruit may be used, including but not limited to banana, strawberry, apple, cherry, blueberry, blackberry peach, mango, pineapple, coconut, orange, tangerine, lemon, lime, etc., including combinations thereof.

“Vegetable particle” as used herein may be prepared by any suitable means, including cryogenic grinding (eg., dry ice or liquid nitrogen), or dehydrating (including air drying, freeze drying, and vacuum drying) etc. Any suitable plant (including legume) or plant part may be used. Examples include, but are not limited to, coffee bean, vanilla bean, cocoa bean, carrot, beet, bell pepper, lettuce, kale, beets, spinach, parsley, basil, cilantro, seaweed, spirulina, etc., including combinations thereof.

“Protein particle” as used herein may be prepared by any suitable method, including filtration (eg., ion exchange or microfiltration), coagulation (including heat, pH, or enzymatic coagulation), and dehydration (including air drying, roller drying, freeze drying, and vacuum drying), etc. Typical proteins include caseins, soy proteins (e.g., soy protein isolate, concentrate or hydrolysate), albumin, non-fat milk solids, milk proteins, whey protein (eg. whey protein isolate or whey protein concentrate), rice protein, wheat protein, oat protein, peptides and protein hydrolysates, and mixtures thereof. See, e.g., U.S. Pat. No. 7,615,246.

“Emulsifier” as used herein includes, but is not limited to distilled monoglycerides, mono- and diglycerides, diacetyl tartaric acid esters of mono- and diglycerides (DATEM), lecithin, emulsifying starches (e.g., octenylsuccinate anhydride starch), tapioca starches, cold swelling starches, modified lecithin, polysorbate 60 or 80, sodium stearyl lactylate, propylene glycol monostearate, succinylated mono- and diglycerides, acetylated mono- and diglycerides, propylene glycol mono- and diesters of fatty acids, polyglycerol esters of fatty acids, lactylic esters of fatty acids, glyceryl monosterate, propylene glycol monopalmitate, glycerol lactopalmitate and glycerol lactostearate, and mixtures thereof. See, e.g., U.S. Pat. No. 7,615,246.

“Fat particle” as used herein includes both liquid oils and solid or semi-solid fats. Suitable fats include, without limitation, non-hydrogenated, partially or fully hydrogenated vegetable oils such as cotton seed oil, soybean oil, corn oil, sunflower oil, palm oil, canola oil, palm kernel oil, peanut oil, MCT oil, rice oil, safflower oil, coconut oil, and their mid- and high-oleic counterparts; or any combination thereof. Animal fats such as milk fat (including butter, heavy cream, half and half and whipped cream) may also be used. See, e.g., U.S. Pat. No. 7,615,246. Fat particles may be produced by any suitable technique, including freeze drying, spray drying, cryogenic grinding (eg., dry ice or liquid nitrogen) or shaving of frozen material and combinations thereof.

“Nutritive and/or health additives” as used herein include proteins (e.g., as described above); fats; carbohydrates; triglycerides; fiber (e.g., soy fiber); amino acids (e.g., histidine, isoleucine, leucine, lysine, methionine, phenylalanine, threonine, tryptophan, valine, alanine, arginine, aspartic acid, cystine, glutamic acid, glycine, proline, serine, tyrosine); L-carnitine, taurine, m-inositol; nucleic acids; fatty acids (omega-3 fatty acids, such as EPA and DHA; polyunsaturated, monounsaturated, and saturated fatty acids, such as linolenic acid, alpha-linolenic, caprylic acid, capric acid, lauric acid, myristic acid, palmitic acid, stearic acid, oleic acid, and arachidic acid); plant phytosterols and plant phytostanols; isoflavones (e.g., daidzein, genistein, glycitein, daidzin, genistin, glycitin, 6″-O-acetyldaidzin, 6″-O-acetylgenistin, 6″-O-acetylglycitin, 6″-O-malonyldaidzin, 6″-O-malonylgenistin, and 6″-O-malonylglycitin); green tea extracts; vitamins (e.g., vitamins A, D, E, K, C, folic acid, thiamin, riboflavin, vitamins B6 and B12, niacin, choline, biotin, panthothenic acid); beta-carotene; phylloquinone; niacinamide; minerals (sodium, potassium, chloride, calcium, phosphorus, magnesium, iodine, manganese, copper, zinc, iron, selenium, chromium, molybdenum); glucosamine sulfate; chondroitin sulfate; hyaluronic acid; s-adenosyl methionine; milk thistle; dandelion, burdock, ginseng, ginger, ginko bilboa, caffeine, guarana, inulin, zeaxanthin, rosmarinic acid, lycopene, lutein, grape extracts, flax seed, and salts, and salts and derivatives thereof. Nutritive and/or health additives may optionally be included, for example, to promote weight gain or loss, cardiovascular health, pediatric health, geriatric health, women's health, etc. See, e.g., U.S. Pat. No. 7,615,246.

“Beverage” as used herein may be any suitable, natural or artificial, alcoholic or non-alcoholic, beverage, including combinations thereof.

“Nonalcoholic beverage” as used herein includes, but is not limited to, milk products (including whole milk, reduced-fat milk, and skim milk) soy milk, fruit juices such as apple, mango, pineapple, grape and orange juices, water, and combinations thereof.

“Alcoholic beverage” as used herein may be any suitable alcoholic beverage, including beer (including meads), wine (including fortified wines) and distilled spirits (e.g., rum, gin, vodka, tequila, whisky, cordials, etc.), each of which may be used alone or in combination with one another or one or more non-alcoholic beverage.

### B. Methods of Making

As noted above, a method of making a frozen instant beverage product, is carried out by mixing a chilled solution as a continuous phase with solid particles. The chilled solution generally comprises or consists essentially of:

water (e.g., in an amount of 10 or 20 percent by weight to 60, 70 or 80 percent by weight (with weight herein referring to the weight of the mixture of chilled solution and solid particles));

a freezing point depressant (e.g., in an amount of 1, 2 or 3 percent by weight up to 20 or 30 percent by weight);

optionally, but in some embodiments preferably, a prebiotic (e.g., in an amount of from 0.1, or 0.5 percent by weight up to 2, 4 or 6 percent by weight);

optionally, but in some embodiment preferably, a thickener or stabilizer (e.g., in an amount of from 0.01 or 0.05 up to 1 or 2 percent by weight);

optionally, but in some embodiments preferably, a sweetener (e.g., in an amount of from 0.01 or 0.5 percent by weight up to 2 or 5 percent by weight for a high intensity sweetener; or still higher for other sweeteners such as corn syrup, e.g., up to 10 or 20 percent); and

optionally, but in some embodiments preferably, an emulsifier (e.g., in an amount of from 0.01 or 0.05 up to 2 or 4 percent by weight).

The solid particles generally comprise or consist essentially of:

ice particles (e.g., in an amount of 10 or 20 percent by weight up to 60, 70 or 80 percent by weight);

optionally, but in some embodiments preferably, flavor particles (e.g., in an amount of 1, 2 or 5 percent by weight up to 40 or 50 percent by weight);

optionally, but in some embodiments preferably, yogurt particles (e.g., in an amount of 5 or 10 percent by weight up to 30 or 50 percent by weight);

optionally, but in some embodiments preferably, fat particles (e.g., in an amount of 0.5% or 1% to about 10 or 20% by weight);

optionally, but in some embodiments preferably, protein particles (e.g., in an amount of 5 or 10 percent by weight up to 30 or 50 percent by weight); and

optionally, but in some embodiments preferably, probiotic particles (e.g., in an amount of 0.1 or 0.5 percent by weight, up to 5 or 10 percent by weight).

The chilled solution can be chilled to any appropriate temperature at which the solid particles (particularly the ice particles) do not melt therein when mixed. In general, the chilled solution is chilled to less than zero degrees centigrade, and is typically cooled to less than −2 or −3 degrees centigrade. The chilled solution can be chilled as much as convenient depending upon the type and amount of freezing point depressant chosen, but is generally not chilled more than −10 or −20 degrees centigrade.

The solid particles can be any suitable size. Typically, the solid particles will be selected so that, when combined with the chilled solution and mixed, a mixture having a paste-like consistency, with the solid particles distributed substantially uniformly in the chilled solution, and appropriate for subsequent forming and shaping, is produced. Typically, the solid particles will be less than 1 millimeter in average diameter. The solid particles can be added to the chilled solution in any suitable sequence, simultaneously or sequentially, whatever is most convenient for the particular product being made or particular equipment being used to carry out the method. Mixing can be carried out in any suitable apparatus, including but not limited to agitators such as scraped-surface agitators, ribbon blenders, V blenders, cone screw blenders, screw blenders, double cone blenders, rotor/stator mixers, dispersion mixers, paddle mixers, etc.

The chilled solution can be prepared with all ingredients therein prior to combining with the solid particles, or additional ingredients can be added during, or even after, the chilled solution is combined with the solid particles. In general, at least the freezing point depressant is included in the chilled solution prior to its combination with the solid particles.

Optional ingredients, for the continuous phase/chilled solution, and/or for the solid particles, include, but are not limited to, buffers, colorants, acidulants, foaming agents, anti-foaming agents, cloudifiers, fiber sources, preservatives, antioxidants, masking agents, and nutritive and/or health additives.

Examples preservatives include, but are not limited to, potassium sorbate, calcium sorbate, sorbic acid and sodium benzoate. Masking agents can be included to mask artificial sweeteners or off-flavors, such as bitter, grassy, beany, or chalky flavors found in some nutritional ingredients and/or vegetable particles. Acidulants can provide sharpness and bite, and also contribute to preservation. Citric, malic, fumaric, ascorbic, lactic, phosphoric, and tartaric acid can be used as acidulants. See, e.g., U.S. Pat. No. 7,615,246.

### C. Products and Methods of Use

Once mixed together, the paste may be formed into any suitable shape by extruding, molding, or any other suitable technique, followed as desired by techniques such as hardening and tempering known in the art (see, e.g., U.S. Pat. No. 7,615,246) to produce a product comprising, consisting of, or consisting essentially of the paste in frozen form. In preferred embodiments, the size, shape and surface area of the frozen product (which may be provided as a plurality or agglomeration of separate parts such as particles) is configured to facilitate the production of a semi-frozen beverage by hand agitation when the frozen product is combined with a liquid beverage.

The frozen product of the invention may be in the form of elongate ribbons or noodles (having any desired cross-section), or in the form of pellets. The pellets may be regular or irregular; the surfaces of the pellets may be smooth or rough; the pellets may be in any suitable shape, including but not limited to rings, spheres, ovals, cubes, cylinders, stars, letters, characters, etc., and combinations thereof. In some embodiments, the pellets have a diameter of about 1 mm to about 20 mm, or any value therebetween (e.g., about 2, 4, 5, 6, 7, 8, 9, 10, 12, 14, 16, or 18 mm).

The frozen product may be coated or uncoated. When coated, the frozen product may be coated with an anti-caking agent (particularly advantageous when the product comprises, consists of or consists essentially of a plurality of like pellets).

The composition of the product (including percentage by weight of the various ingredients) is generally the same as the composition for the mixture given above.

The frozen product may be packaged in any suitable container, including a cardboard carton, a flexible polymer bag or re-sealable polymer bag, a rigid container, etc. A re-usable cup and/or lid may be included if desired, or serve as the packaging itself.

In some embodiments, the frozen product preferably has a shelf life of at least 2 months when stored at a temperature of −20° C.

For use, the products of the invention are mixed with one or more suitable beverages. The beverages, which may be alcoholic or nonalcoholic, are preferably cold or chilled, but in some embodiments may be at room temperature. The frozen product can be combined with the beverage in any suitable pre-determined or arbitrarily chosen amount. For example, the ingredients may be mixed at a weight ratio of frozen instant beverage product to beverage of from 3:1 or 2:1 up to 1:2 or 1:3. In one embodiment, the frozen instant beverage product and the beverage are combined at a weight ratio of about 1:1. Once combined the frozen instant beverage product and the beverage may be mixed by any suitable technique, including but not limited to manual or hand mixing (e.g., hand shaking, hand stirring), mechanical agitation (such as with a manual or electric blender, etc.) to produce a semi-frozen beverage product for consumption, with consumption preferably being at or shortly after the time of mixing. The semi-frozen product, which is preferably substantially homogeneous or uniform in consistency, generally comprises a continuous liquid phase with a solid particle phase therein, the solid particle phase preferably including ice particles (e.g., a major portion thereof) along with any additional particles such as flavor particles previously within the frozen product.

The present invention is explained in greater detail in the following non-limiting examples.

### Example 1

### Process of Making

The product of the present invention is composed of a blend of ice flakes and powdered frozen ingredients combined with a low freezing point solution near its phase-transition temperature (an example is given in Table 1).

Bench top development started with preparation of the freezing-point depressing solution. Water, xylitol, inulin, methylcellulose, and sucralose (These are only example ingredients. Other ingredients may include: manitol, sorbitol, maltitol, erythitol, isomaltitol, lactitol as sweeteners and freezing point depression polyalcohols; other prebiotic ingredients such as galactooligosaccharides, rafinose, and fructooligosaccharides; other thickeners such as carboxymethylcellulose, starches, gums such as xanthan, guar, carageenan, karaya, pectin, gelatin, alginates, and locust bean) are mixed using a hand mixer (A) and cooled to −5° C., just above its freezing point. Ice flakes resembling snow and frozen yogurt flakes were formed using an ice shaving machine (C), then mixed with freeze-dried fruit powder (Air dried may be used in some instances.

TABLE 1
Example Product Formulation

| Ingredient | Weight/serv. (g) | Percentage |
|---|---|---|
| Shaved ice | 43.01 | 30.7 |
| Water | 45.22 | 32.3 |
| Frozen shaved yogurt | 21.51 | 15.4 |
| Xylitol | 12.90 | 9.2 |
| Freeze-dried strawberry | 9.59 | 6.9 |
| Freeze-dried banana | 2.26 | 1.6 |
| Inulin | 2.15 | 1.5 |
| Lactobacillus acidophilus | 1.4 | 1.0 |
| Bifidobacterium animalislactis | 1.4 | 1.0 |
| Methylcellulose | 0.32 | 0.2 |
| Sucralose | 0.14 | 0.1 |
| Natural strawberry flavor WONF | 0.14 | 0.1 |
| Natural banana flavor WONF | 0.10 | 0.1 |

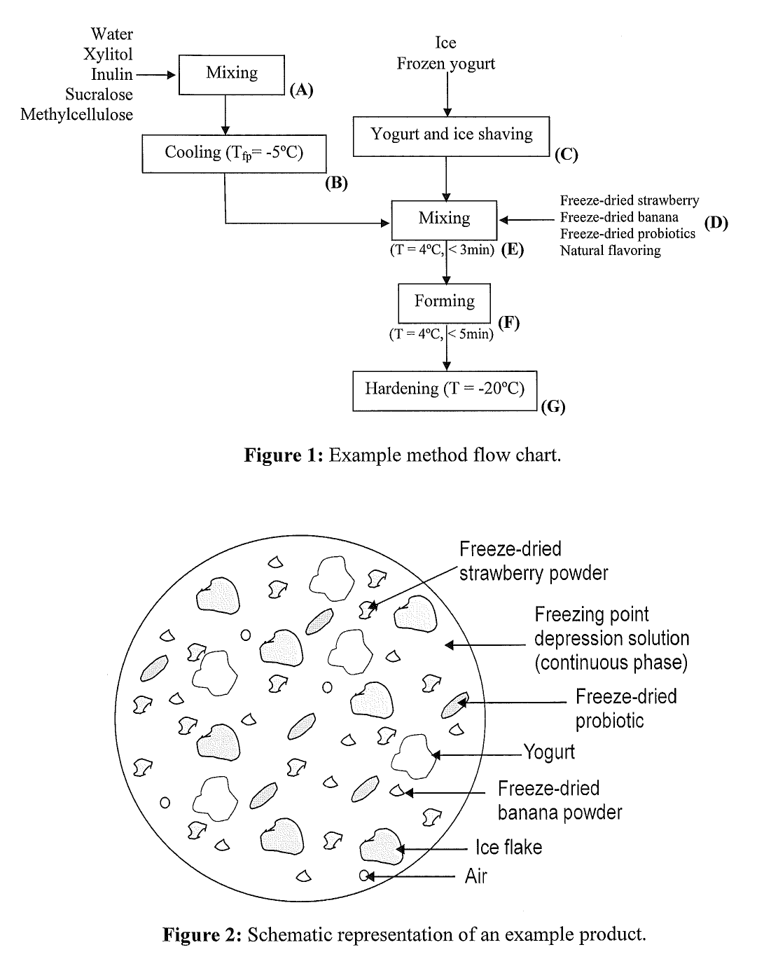

If other non-fruit flavors are desired, dried or concentrated ingredients for those flavors may be used such as but not limited to coffee or chocolate), probiotic cultures (including but not limited to Lactobacillus acidophilus, Bifidobacterium lactis, Lactobacillus casei shirota, Lactobacillus gasseri, Lactobacillus reuteri, Bifidobacterium breve, Bifidobacterium longum), and natural flavoring (D) in a cold room (T=−4±2° C.). The sub-cooled freezing-point depressing solution is added to the frozen, dry ingredients to form a paste (E). The final paste is then formed into small pellets using a cake decorating nozzle (F), and hardened overnight at −20° C. (G) (FIG. 1 and FIG. 2).

### Example 2

### Ingredient Functionality

Xylitol is a polyol with relative sweetness similar to sucrose yet 40% lower in calories (2.4 vs. 4 Kcal/g). With less than half the molecular weight of sucrose (MW=152 vs. 342), xylitol was selected primarily for its greater freezing point depression strength. A sub-cooled aqueous solution (T=−5° C.) was required during the processing of the product to prevent melting of shaved ice and frozen yogurt flakes during ingredient mixing. Moreover, the low freezing-point of the product's continuous phase results in a quick melting product during shaking and effective release of powdered/flaked ingredients into the milk matrix.

Sucralose is a non-nutritive sweetener approximately 600 times sweeter than sucrose, with no noticeable aftertaste. Sucralose was incorporated to provide additional sweetness without increasing the caloric content. Methylcellulose, a cold-water-soluble gum, was added to increase viscosity of the finished, milk-added product. Freeze-dried strawberry and banana fruit powders were added in sufficient amounts to provide one full serving of fruit per smoothie. The high quality of the fruit component also enhances product flavor and appearance, which increases consumer appeal. In addition to real fruit inclusion, natural strawberry and banana flavors were used to augment the fresh fruity flavor of the product. Frozen, powdered yogurt was added to increase the creaminess, as well as to provide the typical flavor of a store-made smoothie. Inulin, a soluble fiber, was used as a fat replacer to increase creaminess and as a prebiotic. Prebiotics stimulate selective growth and/or activity of beneficial bacteria such as Bifidobacteria and Lactobacillus in the gut (J. Cummings et al., Prebiotic digestion and fermentation. Am J Clin Nutr. 73: 415-420 (2001); Y. Bouhnik et al., Prolonged administration of low-dose inulin stimulates the growth of Bifidobacteria in humans. Nutrition Research 27(4): 187-193 (2007); S. Hekmat and D. (1992). Survival of Lactobacillus acidophilus and Bifidobacterium bifidum in ice cream for use as a probiotic food. J of Dairy Science 75: 1415-1422 (1992)). The product also contains a mixture of two freeze-dried probiotics, Bifidobacterium animalis subsp. lactis (HOWARU™ Bifido) and Lactobacillus acidophilus (NCFM), which are added to the frozen ingredient mix at an inoculation rate of 10¹¹ cfu/g to achieve minimum required number of viable cells (10⁶ cfu/g) at the end of shelf-life.

### Example 3

### Thermodynamic Calculations

The product was formulated to achieve several specific functional requirements, including convenience of preparation and the desired flavor profile, nutritional content, texture, and target temperature at consumption. While texture is ingredient dependent, it is also coupled with temperature through the liquid:ice ratio and ice crystal size. It was desired to have a smooth, creamy texture characteristic of freshly-blended smoothies. This is achieved by minimizing the size of the ice crystals and attaining the proper ice-liquid fraction balance, producing a consistency that is icy and creamy yet can be readily pulled through a straw.

Achieving the optimum balance in volume fractions of ice and liquid was addressed through experimentation and by developing an energy balance on the mixing process of the product's pellets and milk. Small ice crystals are usually accomplished by rapid freezing at low temperatures and high heat transfer rates. The product addresses this through the use of xylitol to depress the freezing point of the product's continuous phase, which results in an initial phase change of about −8° C. when cold milk is added with increasing phase change temperature, due to xylitol dilution, to the equilibrium temperature of −2.5° C. During mixing, sensible heat is transferred from the milk to the pellets, initially at −20° C., cooling the milk down to its freezing point (T_{mf}=−0.5° C.), thus forming new ice crystals in the system. The energy lost by the milk (Qₘ) was determined as:

Qₘ=−mₘc_{p,m}(T_{mf}−Tₘᵢ)+mₘx_{mf}λₘ [1]

where mₘ is mass of milk, c_{p,m} is the specific heat of liquid milk, T_{mf} is the freezing point of milk, Tₘᵢ is the initial temperature of milk, x_{mf} is the mass fraction of milk frozen, and λₘ is the latent heat of fusion. Once the pellets reach their phase transition temperature (T_{pf}) no new ice crystal mass may be formed without the loss of existing ice crystal mass (first law of thermodynamics) but the remaining liquid and pellets continue to exchange energy to achieve thermal equilibrium (T_{sys}=T_{pf}). Total energy absorbed by the pellets (Qₚ) was determined as:

Qₚ=mₚc_{p,p}(T_{pf}−Tₚᵢ)+mₚx_{pf}λₚ [2]

where mₚ is the mass of pellets, c_{p,p} is the specific heat of solid pellets, T_{pf} is the freezing point of pellets, Tₚᵢ is the initial temperature of pellets, xₘₚ is the mass fraction of pellets thawed, and λₚ is the latent heat of fusion. Equating energy lost by the milk [1] to energy absorbed by the pellets [2] gives the final energy balance:

−mₘc_{p,m}(T_{mf}−Tₘᵢ)+mₘx_{mf}λₘ=mₚc_{p,p}(T_{pf}−Tₚᵢ)+mₚx_{pf}λₚ [3]

The specific and latent heats of the pellet (c_{p,p}=2.34 kJ/kg° C.; λₚ=193.8 kJ/kg) were determined using differential scanning calorimetry using a single heat flow curve (no baseline subtraction). The DSC was calibrated using indium (melting onset temp=156.6° C.; enthalpy=28.45 J/g) and mercury (melting onset temp=−38.8° C.). Samples were heated at 5° C./min from −50° C. to 80° C. with 4 min isothermal holds at each extreme. The purge gas was nitrogen at a flow rate of 30 cc/min. Samples (50-65 uL) were loaded into stainless steel pans with a micropipette. Pans were hermetically sealed by crimping with a VITRON™ o-ring in the union between the top and bottom of the pan.

The product's final temperature is controlled by solvent concentration at equilibrium following freezing point depression:

ΔT=−K_{f}M [4]

where K_{f} is the freezing point depression constant (1.86° C./molal for xylitol) and M is the molality of water in the product.

Use of the energy balance, equation [3], in combination with equation [4] facilitated understanding of the role that solutes play in affecting phase change temperature by freezing point depression. Though the final formulation was determined largely by experimentation, iterative solution of equations [3] and [4] allowed calculation of the two unknowns, smoothie temperature and liquid to ice ratio at equilibrium, for a specified pellet formulation and milk to pellet ratio.

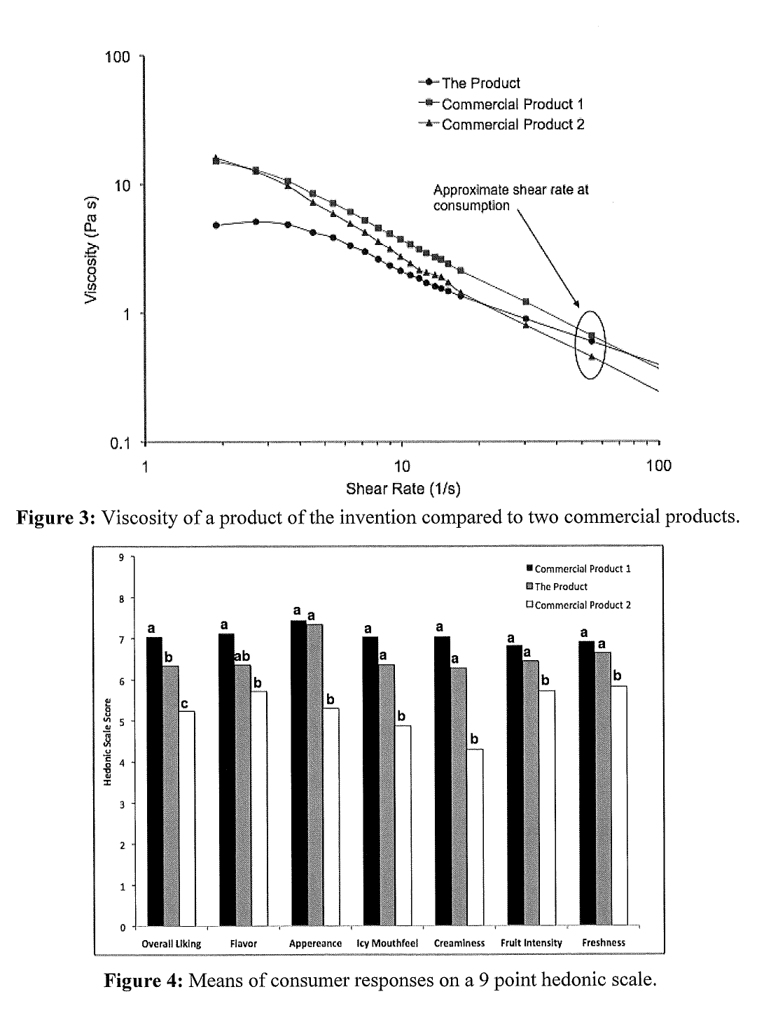

Another technical challenge encountered during development of the product was obtaining a product that quickly dispersed into milk with minimal shaking to produce a frozen, creamy product similar to fruit smoothies prepared in the traditional, less convenient manner. In order to resolve this challenge, several ingredients including freeze-dried fruit, yogurt, and a portion of the water were frozen and powdered/flaked to facilitate their dispersion when the product is shaken with milk. Incorporation of a low freezing point solution that rapidly melts when combined with milk allows for a quick release of the powdered/flaked ingredients during shaking producing a homogenous smoothie with desired viscosity. The viscosity of the product at consumption shear rate (50 l/s) (determined in a Brookfield cone and plate viscometer) was found to be similar to commercial made-to-order smoothies (FIG. 3).

Obtaining the right ingredient and optimum level to effectively decrease the freezing point of the product's continuous phase was also a challenge. Several sugar alcohols were tested, and xylitol functioned the best by creating a homogeneous solution having a low freezing point (T=−8° C.). It was also desired to have a balanced sweet taste to augment the fruity flavors of the product. Although xylitol has a relative sweetness similar to sucrose and provides a clean sweet taste, it could not be used at high concentrations due to its laxative effect, so sucralose was chosen to boost the product's sweetness.

Enhancing the creaminess and mouthfeel of the product also posed a challenge. In order to produce a low-fat, high quality product, several ingredients typically used for fat replacement such as structured lipids, microparticulated proteins, starches, and fibers were considered. Inulin was selected because, in addition to its health benefits, it improved the appearance and perception of creaminess of the final product.

### Example 4

### Acceptance Testing

A consumer test was conducted to determine the overall acceptability of the product and to gain consumer input during product formulation. Participants (n=50) first filled out a demographic questionnaire and then evaluated 3 samples, a product of the present invention and two commercial smoothie mix products, using a 9-pt hedonic scale. All samples were served in 3 oz cups, each identified by a random 3-digit code. Competitor 1 was a pre-packaged smoothie mix sold in the freezer section of a wholesale, membership grocery store. This product contained a variety of frozen berry fruit pieces and yogurt chunks that, when mixed in a blender with milk, created a thick smoothie with visible seed fractions. Competitor 2 was a shelf-stable, bottled smoothie mix that required the addition of ice for blending in a kitchen blender. All samples, including the product of the present invention, were prepared by the testing personnel just prior to being randomly presented to panelists. Participants evaluated each sample for overall liking and other sensory attributes related to appearance, flavor and mouthfeel.

The panel was comprised of 28 females and 22 males, with 70% of consumers between the ages 19 and 35. Ninety-eight percent of participants indicated that they consumed smoothies on a regular basis. The main factors they cited as influencing their smoothie purchases included flavor (24%), price (23%), and nutrition (14%). The overall liking score for the product was 6.4, falling between the scores of competitor products (7.0 and 5.2 for competitors 1 and 2, respectively). No significant differences between the product of the present invention and Competitor B were observed for the following attributes: appearance, icy mouthfeel, creaminess, fruit intensity, and freshness. Moreover, the product of the present invention was significantly more preferred than Competitor B for these attributes (P<0.05). For overall flavor, no significant differences were observed between the product of the present invention and Competitor 1 or 2, even though Competitor 1 and 2 were significantly different from one another (FIG. 4).

Following their evaluation of the three samples of pre-made smoothies, panelists were asked to read the product concept statement, and then presented with a shaking cup containing the products' pellets and a pre-measured amount of milk. Consumers were instructed to prepare the product themselves to determine ease of preparation and evaluate specific sensory attributes of the mixed product.

Based solely on the products' product concept, 88% of consumers indicated they would be willing to try the product. After shaking the product with milk, participants indicated that the product was convenient and extremely easy to prepare. On a 9-pt scale, where 1 represented ‘easy’ and 9 represented ‘hard’, over 80% of participants rated the preparation process 3 or lower. The panelists also agreed (90%) that the finished product was homogeneous after having been shaken with milk for 30 seconds. The product's purchase intent reached 92% after the panelists had prepared and evaluated the product.

Using a 5-pt Just About Right (JAR) scale, consumers also evaluated specific flavor and texture attributes of the product. Strawberry and banana flavors were rated in the ‘just about right’ category by 58% and 54% of consumers, respectively. However, 34% of participants judged that both strawberry and banana flavors were a ‘little too weak’. About 80% of panelists declared that sweetness and thickness of the product were ‘just about right’. Based on consumer responses, slight changes were made to the product's formulation, mainly to improve fruit flavor intensity of the product.

### Example 5

### Shelf Life

Shelf-life of the product is based on the viability of probiotic cultures and quality characteristics of the product during storage. A bench top study indicated that initial freezing of the product caused a reduction of less than one log cycle in total colony counts. After one week of frozen storage, L. acidophilus was at a level of 1.3×10¹⁰ cfu/g, whereas B. lactis was 4.2×10¹⁰ cfu/g. During a 60-day storage period, an 87% survival rate was found among the microorganisms of the mixture. Shelf-life testing of the product was conducted following two approaches, thermal cycling/abuse and extended storage. Thermal cycling/abuse was conducted to determine the effects of repeated short-term exposure to warm conditions, such as that found in the transport chain, on product performance. Of primary concern in this testing was the gross melting and refreezing of the product resulting in a single “ice cube” rather than individual pellets. This amalgamation would potentially result in the loss of the pellets' unique dispersion capability and loss of product performance. Extended storage testing was conducted to determine the effects of low-amplitude thermal cycling such as that found in a home freezer equipped with automatic defrost. Product defects in this environment would principally be development of large ice crystals, which develop through repeated freeze-thaw cycling over time and thus loss of the creamy texture found in the product.

Thermal cycling/abuse was conducted by repeated removal of three 1 oz. cups of pellets from the freezer (−20±2° C.) with alternating placement in a refrigerator (4° C.) for 10 min or at room temperature (22° C.) for 10 min followed by return of the cups to the freezer after the thermal abuse. Each thermal abuse, refrigerated or room temperature exposure, was repeated three times for three days for a total of 18 exposures. On the fourth day, test samples were compared to a control sample (frozen storage only). Evaluation of quality consisted of pellet visual appearance, ease of mixing with milk, and sensory characteristics of the final product. While the test pellets had partially melted together at their pellet-to-pellet contact points, there was no difference in mixing performance between the test and control samples. Informal sensory evaluation of the two finished samples revealed a preference for the abused sample, possibly due to a thicker consistency.

The storage study was conducted by storing three 6 oz cups of product in a −20° C. freezer for 2 months. Sensory evaluation was conducted as with the thermal cycling/abuse study, except that in this case the control was a “freshly made” batch of product pellets. No difference was observed between the test and control samples for pellet appearance and quality parameters of the finished product. Based on the shelf-life testing as well as preliminary probiotic survival testing, a shelf life of at least 2 months is predicted when the product is stored at −20±2° C. or below.

### Example 6

### Processing and Scaling-Up

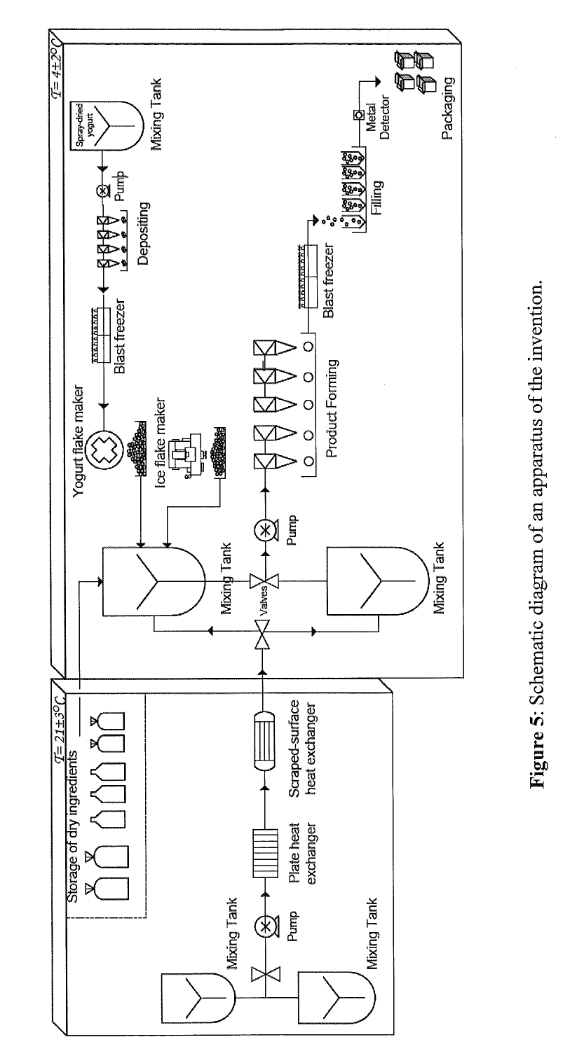

Manufacturing of the product (FIG. 5) starts with preparation of a low freezing point solution. Dry ingredients (such as xylitol, sugar, inulin, and methylcellulose) are mixed with water in one of two vertical tanks equipped with a high shear mixer and load cell weighing to provide continuous flow. After mixing, the solution is pumped through a parallel plate heat exchanger, where the mixture is pasteurized at 72° C./15 sec then pumped through a scraped surface heat exchanger, where it is cooled down to near its phase-transition temperature (T=−5±1° C.). The solution is then pumped to one of two pressurized mixing tanks equipped with a counter rotating scraped surface agitator and load cell weighing for efficient and homogeneous mixing of the solution with powdered, frozen ingredients (ice flakes, frozen yogurt flakes, freeze-dried fruit powders and probiotics). Ice flakes are produced for example using an ice shaving machine (but could be produced by other means such as spray freezing) and conveyed to mixing tanks using an insulated belt conveyer. Spray-dried yogurt is re-hydrated (freeze-dried or fresh may be used in place of spray dried yogurt) in a mixer tank with a high shear mixer, formed into small blocks, conveyed to a tunnel freezer for hardening, then ground into powder using a shaving machine (alternately, liquid yogurt may be spray frozen to produce a flake like product). Frozen yogurt flakes are transferred to mixing tanks using an insulated conveyer belt. Freeze-dried strawberry and banana purees are purchased in powder form and stored in nitrogen flushed double bags. Freeze-dried fruit powders and flavoring are pre-weighed and mechanically added to mixing tanks. Mixed product paste leaving the first tank is extruded through a die forming-head to form a continuous rope of frozen product which is then cut into small pellets (0.5 cm³) (alternately, pellets may be formed by other means such as but not limited to freezing the paste into sheets and cutting or molding into individual shapes using appropriate molds). At the same time, additional product is being mixed in the second tank to allow for semi-continuous processing. Final pellets are conveyed to a tunnel freezer (T=−20° C.) for hardening, individually filled into pouches, passed through a metal detector, packaged, and made available for distribution.

### Example 7

### Packaging

Panelists participating in both the product concept survey and the focus group indicated that they favored environmental friendly packaging. The Canadian Restaurant and Foodservices Association reported that ‘greener’ products, including the adoption of reusable and minimal packaging, was one of the top trends for new beverage products in 2008 (Berry, B. Agri-Food Trade Service CRFA show 2008: Key trends in the North American beverages market (2008)). The product can be sold to consumers as a smoothie kit containing 4 pouches with frozen pellets, 4 spoon/straws, and one 16 oz. reusable shaker cup (not shown). Consumers may also purchase ‘refill’ kits that contain 4 pouches and 4 spoon/straws. The individual serving pouches, containing 6 oz of pellets each, are made of heat sealable, pre-printed polyethylene (PE). They are weighed and imprinted with a batch code before being placed into the secondary packaging. The reusable shaker cup is made from polypropylene (PP), which withstands frozen temperatures. The cup has a screw top that can be easily opened and reclosed for milk addition (or liquid of choice) and it is reusable and dish-washer safe. The cup's label will be digitally printed on a polyvinyl chloride (PVC) conforming shrink wrap. Providing a single reusable shaker cup ensures that consumers can properly and easily prepare the product while also decreasing freezer space, packaging cost and the environmental impact that individual cups or bottles would pose. A high-density polyethylene (HDPE) plastic bag serves as a secondary package. The plastic bag has a resealable opening that has perforations to serve as tamper evidence when the package is opened. The secondary plastic bag is in a stand up form, which allows easy packing of the product for transportation and display in grocery store freezers. To further the environmentally friendly aspects of the package, the product may be sold in bulk packaged resealable bags of suitable plastic material with a measuring scoop contained therein. These units may contain 5, 8 or 10 servings up to 20 or 50 or more servings thereby greatly reducing the packaging mass used per serving.

The foregoing is illustrative of the present invention, and is not to be construed as limiting thereof. The invention is defined by the following claims, with equivalents of the claims to be included therein.

That which is claimed is:

1. A method of making a frozen instant beverage product, comprising:
(a) providing a chilled solution, said chilled solution comprising water and a freezing point depressant;
(b) mixing said chilled solution as a continuous phase with solid particles to produce a mixture thereof, said solid particles comprising ice particles,
and with said mixing step carried out at a temperature at which said frozen ice particles do not melt in said chilled solution; and then
(c) forming said mixture into said frozen instant beverage product.

2. The method of claim 1, wherein said freezing point depressant is a polyol.

3. The method of claim 1, said chilled solution further comprising a prebiotic.

4. The method of claim 1, said chilled solution further comprising a thickener or stabilizer.

5. The method of claim 1, said chilled solution further comprising a sweetener.

6. The method of claim 1, wherein:
said freezing point depressant comprises xylitol, and
said chilled solution further comprises inulin, methylcellulose, and sucralose.

7. The method of claim 1, said mixing step further comprising combining said chilled solution with a probiotic culture.

8. The method of claim 1, wherein said ice particles comprise shaved ice.

9. The method of claim 1, said solid particles further comprising frozen yogurt particles.

10. The method of claim 1, said chilled solution further comprising flavor particles.

11. The method of claim 10, wherein said flavor particles comprise fruit particles.

12. The method of claim 1, wherein said forming step comprises forming said heterogeneous mixture into frozen pellets.

13. The method of claim 1, wherein said frozen instant beverage product has a shelf life of at least 2 months when stored at a temperature of −20° C.

14. A frozen instant beverage product comprising a continuous phase and a particulate phase;
said continuous phase comprising water and a freezing point depressant; and
said particulate phase comprising ice particles.

15. The product of claim 14, said particulate phase further comprising flavor particles.

16. The product of claim 15, wherein said flavor particles comprise fruit particles.

17. The product of claim 14, wherein said particulate phase further comprises yogurt particles.

18. The product of claim 14, wherein said continuous phase further comprises a prebiotic.

19. The product of claim 14, wherein said continuous phase further comprises a thickener or stabilizer.

20. A method of making a semi-frozen beverage, comprising:
mixing a frozen instant beverage product of claim 14 with a beverage to produce said semi-frozen beverage.

21. The method of claim 20, wherein said beverage comprises a nonalcoholic beverage.

22. The method of claim 20, wherein said beverage comprises an alcoholic beverage.
